(19) United States
(12) Patent Application Publication
(10) Pub. No.: US 2017/0203135 A1
(43) Pub. Date: Jul. 20, 2017

(54) CELLULAR TELEPHONE FIRE SUPPRESSION PACKET

(71) Applicant: GelTech Solutions, Inc., Jupiter, FL (US)

(72) Inventor: Peter Cordani, Palm Beach Gardens, FL (US)

(21) Appl. No.: 15/427,915

(22) Filed: Feb. 8, 2017

Related U.S. Application Data
(63) Continuation-in-part of application No. 14/682,542, filed on Apr. 9, 2015.
Application No. 14/682,542 is a continuation-in-part of application No. 14/620,925, filed on Feb. 12, 2015.
(60) Provisional application No. 62/064,011, filed on Oct. 15, 2014.

(51) Int. Cl. A62D 1/00; B65D 75/30; A62C 35/10; B65D 65/38; H01M 10/0525; A62C 3/16

(52) U.S. Cl. CPC A62D 1/0007; H01M 10/0525; A62C 3/16; A62C 35/10; B65D 65/38; B65D 75/30; H01M 2220/30; H01M 2200/10; A62C 99/0045

(57) ABSTRACT

A packet containing an admixture for use in suppressing a cellular telephone battery fire. The packet contains an admixture of a hydrated super absorbent polymer having substantially superior fire suppression and extinguishing properties. When used with lithium batteries, once a battery is arcing or an excess buildup of heat occurs, the packet will rupture and the admixture will cover the specific area. These particular properties and ratios of the admixture will enable a fire to be extinguished.

### PRIORITY CLAIM

In accordance with 37 C.F.R. 1.76, a claim of priority is included in an Application Data Sheet filed concurrently herewith. Accordingly, the present invention is a Continuation-In-Part application that claims priority to U.S. application Ser. No. 14/682,542 entitled “FIRE SUPPRESSION PACKAGING”, filed Apr. 9, 2015, which is a Continuation-In-Part application that claims priority to U.S. application Ser. No. 14/620,925, entitled “FIRE SUPPRESSION PACKAGING AND METHOD OF MANUFACTURE”, filed Feb. 12, 2015, which claims priority to U.S. Provisional Patent Application No. 62/064,011, entitled “BATTERY STORAGE DEVICE AND METHOD OF MANUFACTURE”, filed Oct. 15, 2014. The contents of the above referenced applications are incorporated herein by reference.

### FIELD OF THE INVENTION

This invention relates to the field of fire protection, and more particularly, to an insert packet for use with cellular telephones, and the like smart devices, by employing hydrated amounts of super absorbent polymer constructed and arranged to arrest and extinguish a battery fire.

### BACKGROUND OF THE INVENTION

The problem with cellular telephone fires is well known. Samsung Galaxy Note 7 is likely the most well know smart phone battery failure due to a major recall. However, Samsung is not alone with lithium battery fires being a problem. Dell also had problems that affected nearly six million computers. Unfortunately, all lithium batteries are at risk should there be a flaw in manufacturing or if the lithium battery is not properly recharged. Poor manufacturing can result in latent electrical short circuits. Overcharging can result in oxygen bubbles forming in the lithium gel, which is reactive with metallic lithium. Thermal runaway is also common, the result of a feedback loop in which a lithium battery can quickly overheat and explode.

Even the best made lithium batteries can fail. For instance, recharging a battery in sub freezing temperature can cause permanent plating of the metallic lithium, which can lead to battery failure. Breach of the housing can also cause lithium to catch fire when it is exposed to oxygen or water.

The Department of Transportation (DOT), through the Pipeline and Hazardous Materials Safety Administration (PHMSA), recognized the problem as far back as 2008, and prohibits loose lithium batteries in checked baggage. Many planes now include charging terminals at the passenger seat However, since recharging of a telephone is known to uncover latent defects, the charging of telephones while in flight may pose further fire risks.

### SUMMARY OF THE INVENTION

Disclosed is an insert packet containing an admixture capable of suppressing or extinguishing a lithium battery fire in a cellular telephone or the like smart device. The packet includes a hydrated super absorbent polymer in a package thin enough to be placed between a cellular telephone and a protective case, positioning the packet adjacent to the smart phone battery. Should an arcing of the lithium battery occur, the packet will release the admixture to extinguish the battery fire. The admixture is used to saturate the immediate area around the battery, further providing a benefit of cooling down the battery. The admixture viscosity inhibits flowing to adjacent areas and is non-conductive. The packet can also be molded into casings or shells which are fitted onto larger devices such as iPads and laptops.

Accordingly, it is an objective of the present invention to provide an insert packet containing an admixture of non-conductive hydrated super absorbent polymer for extinguishment of lithium battery fires associated with cellular telephones and the like smart devices.

Still another objective of the present invention is to provide a packet that is thin enough to be either positioned between a cellular telephone and its protective casing, or to be integrated into the protective casing.

It is still yet another objective of the present invention to provide a packet with an admixture of hydrated super absorbent polymer having a viscosity that will retain a shape for a period of time. The viscosity also enables the admixture to adhere to horizontal, vertical, inclined, and curved surfaces.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an exploded view of a cellular telephone with a protective case, wherein a package of hydrated polymer is placed between the phone and the case;

FIG. 2 is an exploded view of a cellular telephone with protective case, wherein a packet of hydrated polymer can be placed within a cavity formed in the case; and

FIG. 3 is a view of a cellular telephone with a protective case, wherein a packet of hydrated polymer is formed integral with the case.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention relates to a packet of material that can be placed between a cellular telephone and its protective case, or formed integral with the protective case. The packet contains an admixture of hydrated super absorbent polymer in an amount sufficient to extinguish a battery fire.

Battery fires present different and unique problems pertaining to how these fires should be extinguished and suppressed. While water is commonly employed to extinguish fires because it can quickly cool down the burning material, water does not necessarily work on a battery fire, especially since water may short circuit a battery and/or operating device. In the preferred embodiment of the present invention, an admixture of a super absorbent polymer and water is placed adjacent the phone battery, either formed integral with a protective casing or between the phone and the protective casing. By catching the fire at its conception, the possibility of extinguishment is greatly increased.

The aqueous admixture of the super absorbent polymer has properties which enable the polymer to be confined to a particular area because of its relatively high viscosity. The properties of the admixture, in particular its viscosity, enable the admixture to remain on vertical, horizontal, and curved surfaces formed by the packet. Unlike pure water, the admixture does not provide an electrically conductive path. The present invention adds a predetermined amount of polymer to a predetermined amount of water to obtain an admixture which has properties that enable the dissipation of heat and suppress the spread of a battery fire. In this embodiment, about one tablespoon of material is employed as the admixture will be juxtapositioned to the battery. It is to be understood that the ratio of super absorbent polymer to water can vary to produce various physical states of the super absorbent polymer. For example, the viscosity can be adjusted to form a gel, slurry, liquid, semi-liquid, and/or foam. In a preferred embodiment, the ratio of super absorbent polymer to water is adjusted to produce a gel.

Accordingly, in one embodiment, a super absorbent aqueous based polymer is added to water in a dry weight from about 0.1 gram to about 100 kilograms, wherein the volume of water ranges from about 0.1 liters to about 100 liters. The preferred vendor of a potassium based super absorbent polymer is by the Applicant GelTech Solutions, Inc., and marketed under the trademark FIREICE®.

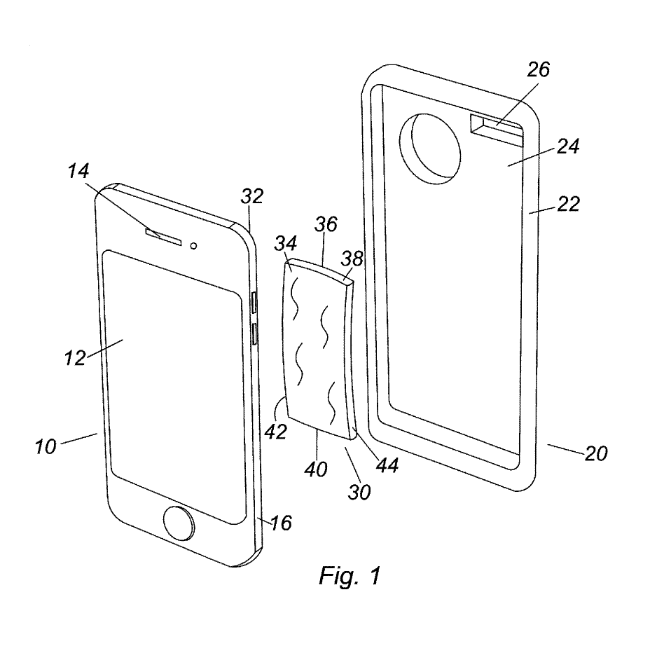

Referring now to FIG. 1, illustrated is a conventional cellular smart phone 10 having a display surface 12, a speaker 14, and a continuous side wall 16. Smart phones are known to be easily broken when dropped, and most consumers include a protective case to extend the longevity of the smart phone. A conventional case 20 is depicted, having a continuous side edge 22 with a back wall 24. The case 20 typically includes an aperture 26 which allows a camera mechanism on the smart phone to operate without the removal of the case 20. Insert packet 30 is positioned between the smart phone 10 and the case 20, and is strategically placed next to the rear side wall 32 of the smart phone housing the lithium battery. The packet 30 includes a front side wall 34, a rear side wall 36, top edge 38, lower edge 40 and opposing side edges 42 and 44. The sidewalls may be formed from a material selected from the group of low density polypropylene, polypropylene, polyethylene, polyurethane, polyisoprene, plastics, or combinations thereof. The use of a flexible material is selected for its ability to be flexible and leak resistant, with an ability to hold the hydrated material over a long period of time without evaporation. Polypropylene is a preferred embodiment.

Approximately one tablespoon of super absorbent polymer is placed within the packet. The admixture is a biodegradable, super absorbent, aqueous-based cross-linked modified polyacrylamide/potassium acrylate polymer. Other polymers may be used, but not with the same quality level. Examples of these polymers are cross-linked modified polyacrylamides/sodium acrylate, carboxy-methylcellulose, alginic acid, cross-linked starches, and cross-linked polyaminoacids. The front wall and rear wall are sealed along the side edges by weldment, bonding, adhesive or any other type of securement, so as to permanently entrap the super absorbent polymer within the packet.

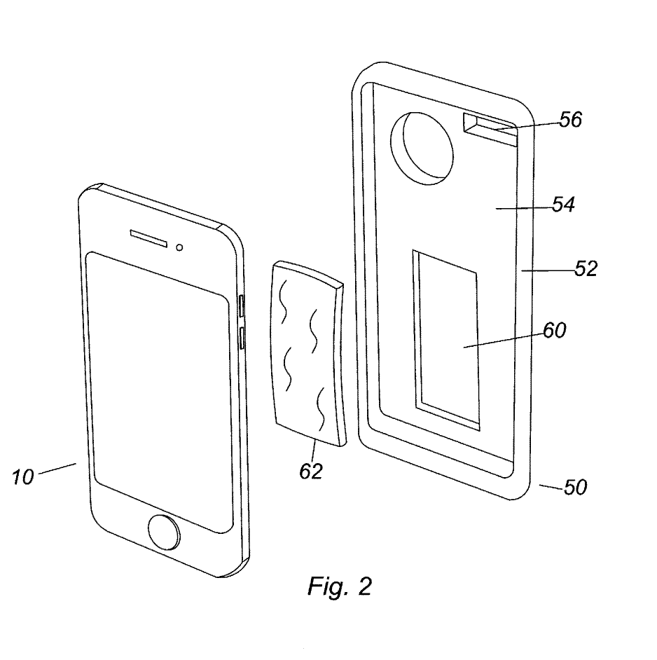

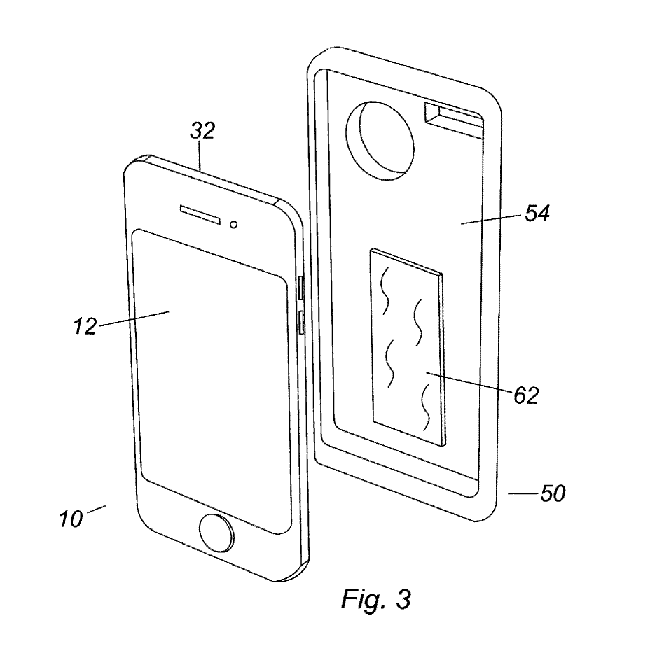

FIG. 2 sets forth an embodiment having the smart phone 10 for placement over the case 50 having a continuous side wall 52, back wall 54, and camera aperture 56. In this embodiment, the back wall 54 includes an aperture 60 for receipt of a packet 62. In this embodiment, the packet 62 would be positioned flush within the case as depicted in FIG. 3, allowing the case to be made very thin and maximize the amount of super absorbent polymer. The placement of the packet adjacent to the rear wall of the smart phone casing has been found to be the most optimal position to arrest a lithium battery fire. The display surface 12 of the smart phone 10 is positioned to face outward from the case, wherein immediate heat buildup would be between the rear wall 32 of the smart phone 10 and the back wall 54 of the case 50. By placing the packet 62 adjacent the battery wall, the packet helps to diffuse heat buildup and, in the case of a thermal meltdown, the packet side wall would be breached, allowing release of the super absorbent polymer directly to the cause of the breach which, in the case of a fire, is immediate heat creation. Should a battery overheat, at least a portion of the packet would be breached, wherein the side wall would allow the hydrated polymer to flow towards the overheated battery for purposes of suppression or extinguishment.

The sidewalls may be continuous or secured to an opposing sidewall by bonding, weldment, adhesive, or any other type of bonding. Should a stored battery overheat, at least a portion of the packet will breach, wherein the packet sidewall will allow the hydrated polymer to flow and address the overheated battery.

The super absorbent polymer is preferably potassium based and hydrated at a level to make a non-conductive admixture. In particular, the super absorbent polymer is an admixture of polyacrylamides/potassium acrylate marketed under the trademark FIREICE®. The insert packet can be flexible, semi-flexible, rigid or combinations thereof; for example, the first sheet is rigid and the second sheet is flexible, allowing for the insert to be placed in a packet container along the length and breadth of the container sides, while the flexible second sheet allows for expansion so as to contain large volumes of the admixture. The insert can optionally be adhered to a surface of a case. For example, the insert can be adhered to the inner walls of the packet container or adhere to an object that is to be packaged. The first and second sheets can be sealable or resealable. For example, the inserts can be filled with the admixture at the point of packaging and sealed. Accordingly, in one embodiment, at least one edge is optionally resealable. The packets can also be manufactured in any size, shape or conformation. In some embodiments, the insert is shaped and dimensioned depending on the packet container; the shapes and dimensions of the insert comprising: squares, rectangles, triangles, spheres or any combinations thereof.

In some embodiments, the fire suppressant or fire extinguishing composition is a biodegradable, super absorbent, aqueous-based polymer. The fire extinguishing or fire suppressant can be any known or conventional fire suppressant, including biodegradable, super absorbent, aqueous-based polymers. Examples of these polymers are cross-linked modified polyacrylamides/potassium acrylate or polyacrylamides/sodium acrylate. Other suitable polymers include, albeit are not limited to, carboxy-methylcellulose, alginic acid, cross-linked starches, and cross-linked polyaminoacids. Examples of known fire suppressants include, without limitation, those marketed under the brand name of FIREICE marketed by GelTech, Barricade II marketed by Barricade International, Thermo Gel 500p marketed by Thermo Industries, AFG Firewall marketed by NoChar, Phos-Chek, AquaGel-K, Focstop-K or Insul-8 marketed by ICL Performance Products, Blaze Tamer 380 marketed by Bio Central Labs, and Tetra KO marketed by Earth Clean Corporation. Other known materials that can be made effective include Purple K potassium bicarbonate, mono ammonium phosphate, sodium bicarbonate, potassium bicarbonate & Urea Complex (AKA Monnex), potassium chloride (Super-K), MET-L-KYL/PYROKYL variation of sodium bicarbonate, a blended sodium chloride, or a copper extinguishing agent such as that developed by the U.S. Navy for fighting lithium and lithium alloy fires. The copper compound smothers the fire and provides an excellent heat sink for dissipating heat.

The packet may also be included as an OEM addition and be shipped with the original sale of the cellular telephone. The cellular telephone packaging is conventionally formed from Styrofoam wherein a depression can be made in the packaging so as to maintain the packet against the cellular telephone during shipping and storage. This will assure safety in shipping for even new telephones can short circuit if the conditions are right.

As used herein, a “fire suppressant” and “fire extinguishing” composition is used interchangeably, and is meant to be inclusive of all components of the composition. In some embodiments, the fire extinguishing composition comprises one or more fire suppressant compounds. In other embodiments, the fire extinguishing composition comprises one or more common components of fire suppressant formulations, such as: fire suppressant salts, known or conventional fire suppressants, corrosion inhibitors, spoilage inhibitors, foaming agents, non-foaming agents, flow conditioners, stability additives, thickening agents, pigments, dyes or the like.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fire extinguishing packet for use with a cellular telephone containing a lithium battery comprising:
a packet constructed from a flexible sheet of material having a first side wall defined by first and second end edges and first and second longitudinal side edges, and a second side wall having a mirror image of said first side wall and secured to said first side wall, forming a space therebetween, said packet constructed and arranged to fit between a cellular telephone and a cellular telephone protective casing;
an admixture of hydrated super absorbent polymer capable of treating a lithium battery fire contained in said space;
wherein a lithium battery breach will create excessive heat capable of melting a portion of said packet and releasing said admixture, said admixture dissipating lithium battery excess heat and associated fire.

2. The fire extinguishing packet according to claim 1 wherein said flexible sheet of material is polypropylene.

3. The fire extinguishing packet according to claim 1 wherein said flexible sheet of material is selected from the group consisting of: low density polypropylene, polypropylene, polyesters, polyethylene, polyurethane, polyisoprene, elastomers, rubber-like resilient materials, silicone rubber, nitrile rubber, butyl rubber or combinations thereof.

4. The fire extinguishing packet according to claim 1 wherein said admixture is potassium based.

5. The fire extinguishing packet according to claim 1 wherein said admixture is an admixture of a combination of polyacrylamides and potassium acrylate.

6. The fire extinguishing packet according to claim 4 wherein said admixture is marketed under the brand FireIce®.

7. The fire extinguishing packet according to claim 1 wherein said admixture is about one tablespoon in volume.

8. The fire extinguishing packet according to claim 1 wherein said admixture has a ratio of about 1 gram of said super absorbent polymer hydrated with about 0.4 liters of water.

9. The fire extinguishing packet according to claim 1 wherein said packet is constructed and arranged to be placed in a cellular telephone protective case having an aperture sized to receive said packet.

10. The fire extinguishing packet according to claim 1 wherein said packet is secured to the cellular telephone protective case.

11. The fire extinguishing packet according to claim 1 wherein said packet is formed integral to the cellular telephone protective case.

12. The fire extinguishing packet according to claim 1 wherein said edges are sealed by heat welding, glue, adhesion tape, or combinations thereof.
